(19) United States
(12) Patent Application Publication
(10) Pub. No.: US 2010/0083714 A1
(43) Pub. Date: Apr. 8, 2010

(54) Magnetic Lock for Windows

(76) Inventors: Garth C. Keighley, Wellington (NZ); Mathew D. Ruspil, Reno, NV (US)

Correspondence Address: David Chen;Delio and Peterson LLC, 121 Whitney Avenue, New Haven, CT, 06510-1214, US

(21) Appl. No.: 12/569,135

(22) Filed: Sep. 29, 2009

Related U.S. Application Data
(63) Continuation-in-part of application No. 12/245,761, filed on Oct. 5, 2008.

(51) Int. Cl. E05B 65/00; E05C 19/16

(52) U.S. Cl. 70/89; 292/251.5

(57) ABSTRACT

The invention relates to a magnetic lock for a window comprising a button having a locked position and an unlocked position, a spring clip in contact with the button for holding the button in the unlocked position, and a trigger wheel. The lock also has a trigger housing with an activated position and a deactivated position, and where the trigger wheel is attached to and rotatable on the trigger housing. Movement of the trigger housing causes the trigger wheel to move and contact the spring clip. Additionally, contact between the trigger wheel with the spring clip causes the spring clip to move and allow the button to move from the unlocked position to the locked position.

### CROSS REFERENCED TO RELATED APPLICATION

This is a continuation-in-part patent application that claims priority to and the benefit of U.S. Non-Provisional patent application Ser. No. 12/245,761 filed Oct. 5, 2008, titled “Magnetic Lock for Windows,” which is incorporated herein by reference in its entirety.

### BACKGROUND OF THE INVENTION

1. Field of the Invention

The invention relates to a lock mechanism for a window.

2. Background of the Invention

A double-hung, single hung, and double slider window assembly typically includes a window frame and a pair of window sashes mounted for vertical reciprocal sliding movement, one relative to the other, in guide rails of the master frame jamb of the window assembly.

A traditional lock for a double hung window usually involves a part of the lock on one sash and the other part of the lock on the other sash, wherein joining the two parts of the lock together results in locking the sashes to one another.

One disadvantage of this type of lock is that it normally requires the sashes be a certain distance away from one another, wherein the sashes being too close or too far apart may render the lock ineffective. For example, if the sashes are spaced too far apart, the two parts of the lock may not be able to be joined together and the window may not lock. If the sashes are too close together, the parts of the lock may bind or interfere with one another, resulting in the parts not being able to mate together and therefore the window may not be locked. These problems may occur during installation where the installer must adjust the window sashes and lock, perhaps numerous times, before achieving a proper fit between the sashes and lock. These problems may also occur over time when windows become old, warped, or damaged through normal wear.

As a result of the foregoing disadvantage, the lock and/or window may need to be replaced without any assurance that the problems will not reoccur. In addition, forcibly pushing the sashes together in order to bring them to a proper distance may result in stress upon the frame around the sashes and/or the glass panes. Continuing to use the lock and window in this fashion can exacerbate the problems.

What is desired, therefore, is a lock that is more flexible to use than a traditional lock. Another desire is a lock that accommodates changes in the spacing between the sashes. A further desire is a lock that is more resistant to damage than a traditional lock without sacrificing reliability. Yet another desire is a lock that works for sashes that have a varying distance between them. Another desire is a lock that automatically locks a window without physical interaction with the strike or window in order to change states; from unlocked to locked positions. A further desire is a lock with multiple drive options to be utilized based off of an application type and furniture design. It is also desirable to provide a lock indicator for indicating whether or not the lock is locked or unlocked.

### SUMMARY OF THE INVENTION

Bearing in mind the problems and deficiencies of the prior art, it is therefore an object of the present invention to provide a lock that accommodates variations in the spacing between the sashes.

It is another object of the present invention to provide a lock that automatically secures the window without physical interaction with the strike or window in order for the lock to move from an unlocked position to a locked position.

A further object of the invention is to provide a lock that overcomes the disadvantages of a traditional lock stated above.

Still other objects and advantages of the invention will in part be obvious and will in part be apparent from the specification.

Yet another object is a lock that provides an indicator for indicating whether or not the lock is in an unlocked or locked position.

The above and other objects, which will be apparent to those skilled in the art, are achieved in the present invention which is directed to a lock for a window comprising a button having a locked position and an unlocked position, a spring clip in contact with the button for holding the button in the unlocked position, and a trigger wheel. The lock also has a trigger housing with an activated position and a deactivated position, and where the trigger wheel is attached to and rotatable on the trigger housing. Movement of the trigger housing causes the trigger wheel to move into contact with the spring clip. Additionally, contact between the trigger wheel with the spring clip causes the spring clip to move and allow the button to move from the unlocked position to the locked position.

In optional embodiments, the trigger wheel has a first protrusion and a second protrusion. In one of these embodiments, the second protrusion rotates between a first position and a second position for controlling a rotation of the trigger wheel. In another one of these embodiments, contact between the second stop and the trigger wheel causes the trigger wheel to reset to the deactivated position when the trigger housing is in the deactivated position. In a further one of these embodiments, movement of the trigger housing toward the locked position causes the trigger wheel to move, wherein the second protrusion contacts the first stop and the first stop inhibits the first protrusion from rotating around the spring clip, and wherein the first stop causes the first protrusion to contact and move the spring clip to allow the button to move from the unlocked position to the locked position.

In some embodiments, the trigger housing includes a spring for biasing the trigger housing toward a deactivated position, and the trigger housing includes a magnet where actuation of the magnet causes the trigger housing to move from the deactivated position to the activated position.

In other embodiments, deactivation of the magnet allows the spring to bias the trigger housing toward the deactivated position.

In further embodiments, movement of the button from the locked position to the unlocked position causes the spring clip to come in contact with a wall and where the wall holds the spring clip and the button in the unlocked position. In some of these embodiments, movement of the trigger housing toward the deactivated position causes the first protrusion to rotate around the spring clip without releasing the spring clip from the wall.

In another embodiment, the trigger wheel freely rotates clockwise and counterclockwise about an axis passing through the trigger housing.

In some embodiments, the spring clip is attached to the button. In other embodiments, the spring clip is attached to a housing.

In another aspect of the invention, a lock for a window comprises a button having a locked position and an unlocked position, a spring clip in contact with the button, a wall in contact with the spring clip for holding the button in the unlocked position, and a trigger wheel with a protrusion, where the protrusion rotates between a first position and a second position for controlling a rotation of the trigger wheel. The invention also has a trigger housing with an activated position and a deactivated position, where the trigger wheel is attached to and rotatable on the trigger housing.

In optional embodiments, the first position is defined by a first stop on the trigger housing for controlling a counterclockwise rotation of the trigger wheel. In some of these embodiments, the first stop, when in contact with the protrusion, inhibits movement of the protrusion and causes the trigger wheel to move the spring clip and allow the button to move from the unlocked position to the locked position.

In other embodiments, the second position is defined by a second stop on a housing for controlling a clockwise rotation of the trigger wheel. In some of these embodiments, the second stop, when in contact with the trigger wheel, causes the trigger wheel to reset to the deactivated position when the trigger housing is in the deactivated position.

In a further embodiment, the spring clip has a first portion and a second portion, and the wall is in contact with the first portion for holding the button in the unlocked position. In a variation of this embodiment, the protrusion contacts the second portion for moving the spring clip and allowing the button to move from the unlocked position to the locked position.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the lock in accordance with the invention.

FIG. 2 more particularly depicts the lock shown in FIG. 1.

FIG. 3 depicts the inside of the lock shown in FIG. 1.

FIG. 4 depicts an assembly view of the lock shown in FIG. 1.

FIG. 5 depicts a top view of the lock shown in FIG. 1 in a locked position.

FIG. 6 depicts a top view of the lock shown in FIG. 1 in an unlocked position.

FIG. 7 depicts a top view of the lock with strike shown in FIG. 1 in a locked position.

FIG. 8 depicts a more detailed top view of the lock shown in FIG. 1 in a locked position.

FIG. 9 more particularly depicts the engagement of the spring clip, button, and trigger shown in FIG. 1.

FIG. 10 more particularly depicts the trigger shown in FIG. 1.

FIG. 11 is a cross sectional view of the lock taken across line 11-11 shown in FIG. 5;

FIG. 12 is a cross sectional view of the lock taken across line 12-12 shown in FIG. 5.

FIG. 13 depicts a method for providing the lock shown in FIG. 1.

FIG. 14 depicts the lock shown in FIG. 1 using a strike magnet that attracts the magnet in the housing.

FIG. 15 depicts a detailed top view of the lock shown in FIG. 1 using a strike magnet that attracts the magnet in the housing.

FIG. 16 depicts the engagement of the button, spring clip, and trigger shown in FIG. 1 using a strike magnet that attracts the magnet in the housing.

FIG. 17 more particularly depicts the trigger shown in FIG. 1 using a strike magnet that attracts the magnet in the housing.

FIG. 18 depicts another detailed view of the inside of the lock shown in FIG. 1.

FIG. 19 depicts push plate 18 shown in FIG. 1 being used as an indicator for indicating whether or not the lock shown in FIG. 1 is locked or unlocked.

FIG. 20 depicts a variation of the lock shown in FIG. 1.

FIG. 21 depicts a perspective view of an inside of the lock shown in FIG. 20.

FIG. 22 depicts a perspective view of an assembly of the lock shown in FIG. 20.

FIG. 23 depicts a front view of the lock of FIG. 20 in an unlocked position with the window opened.

FIG. 24 depicts a front view of the lock of FIG. 20 with the window closed and the trigger housing actuated.

FIG. 25 depicts a front view of the lock of FIG. 20 with the window closed and locked, where the trigger housing has already actuated the button.

FIG. 26 depicts a front view of the lock of FIG. 20 with the window closed and being manually unlocked by a user.

FIG. 27 depicts a front view of the lock of FIG. 20 with the window being opened and the trigger housing being deactivated.

FIG. 28 depicts a front view of the lock of FIG. 20 with the window opened and lock returning to the unlocked position.

FIGS. 29a-29b depict a rear view of the lock shown in FIG. 20.

FIG. 30 depicts a close up perspective view of the trigger housing shown in FIG. 20.

FIG. 31 depicts a cross sectional view of the lock shown in FIG. 20 taken through the button.

FIG. 32 depicts a cross sectional view of the lock shown in FIG. 20 taken through the trigger housing.

FIG. 33 depicts a perspective view of the hook shown in FIG. 20.

FIG. 34 depicts a top view of another embodiment of the trigger housing shown in FIG. 20.

FIGS. 35-36 depict perspective views of the trigger housing shown in FIG. 34.

FIGS. 37-38 depict perspective views of another embodiment of the trigger wheel shown in FIG. 20.

FIG. 39 depicts a top view of the trigger wheel and trigger housing shown in FIGS. 34-38.

FIG. 40 depicts a perspective view of the trigger wheel and trigger housing shown in FIGS. 34-38.

### DETAILED DESCRIPTION OF THE DRAWINGS

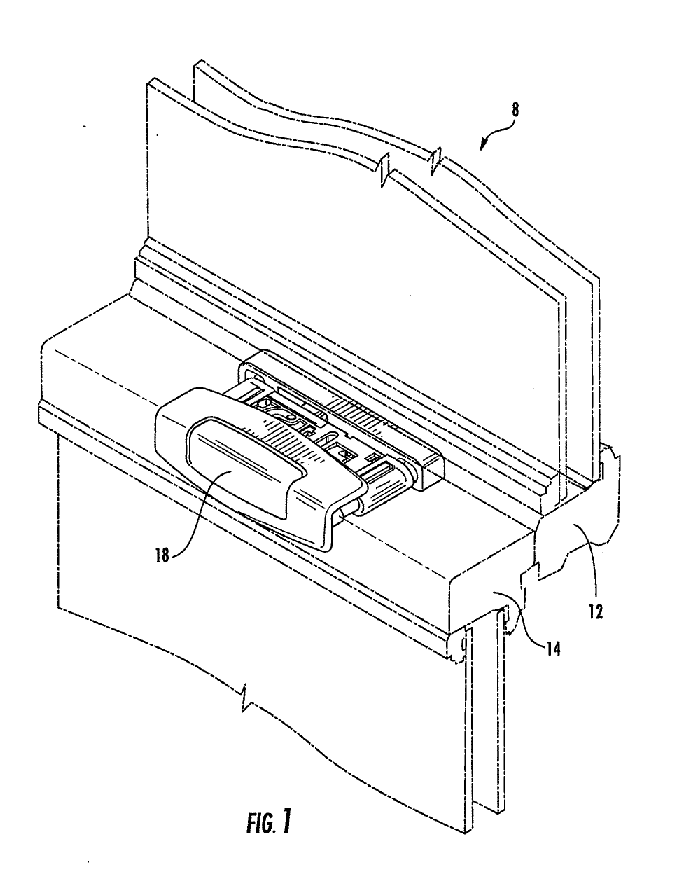

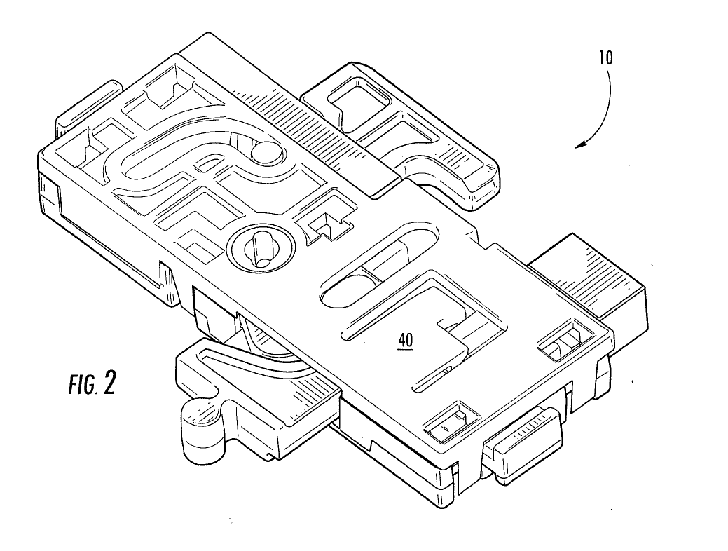

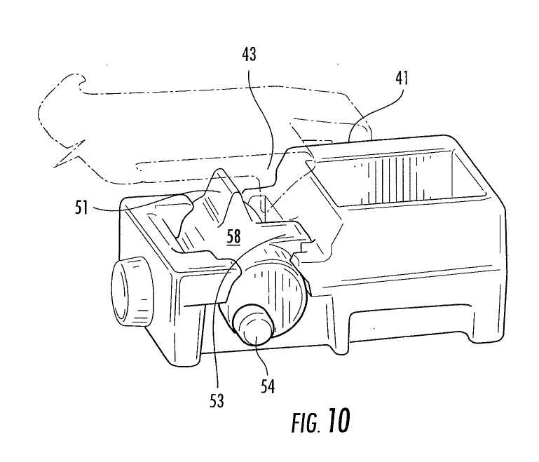

In describing the preferred embodiment of the present invention, reference will be made herein to FIGS. 1-32 of the drawings in which like numerals refer to like features of the invention.

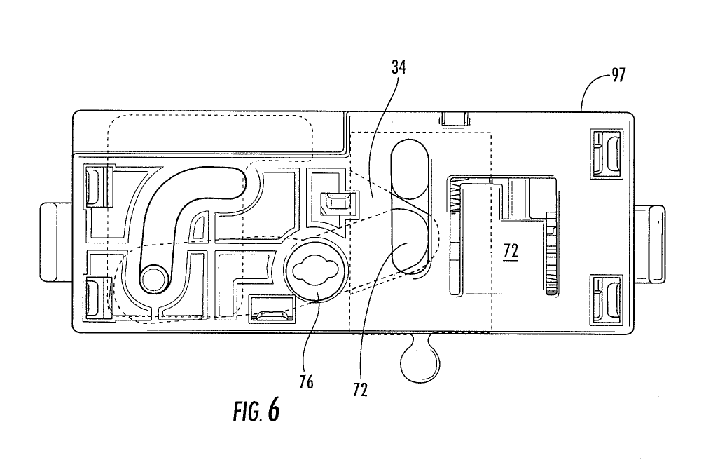

FIGS. 1 and 7 depict lock 10 in accordance with the invention, where lock 10 secures sashes 12, 14 together, resulting in window 8 being locked. As shown, strike 20 and strike magnet 44 are placed on or within sash 12 and the remaining components of lock 10 are placed on or within sash 14, wherein hook 68 mates with or contacts shoulder 22 of strike 20 to secure sashes 12, 14 together.

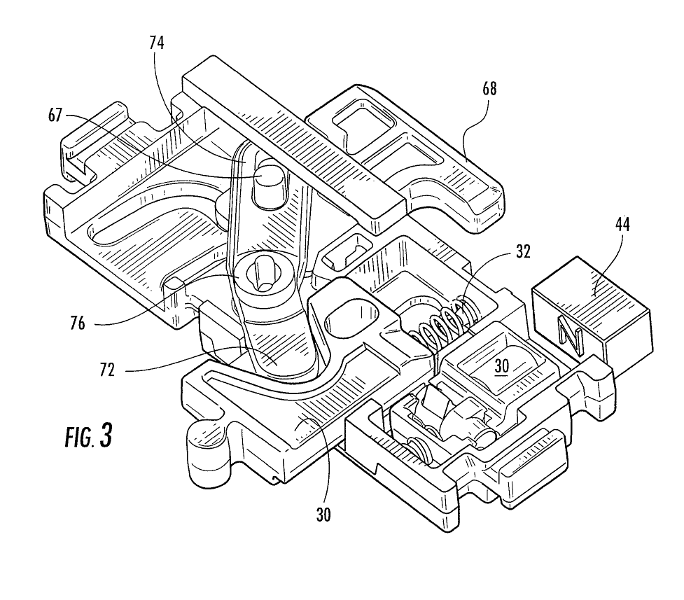

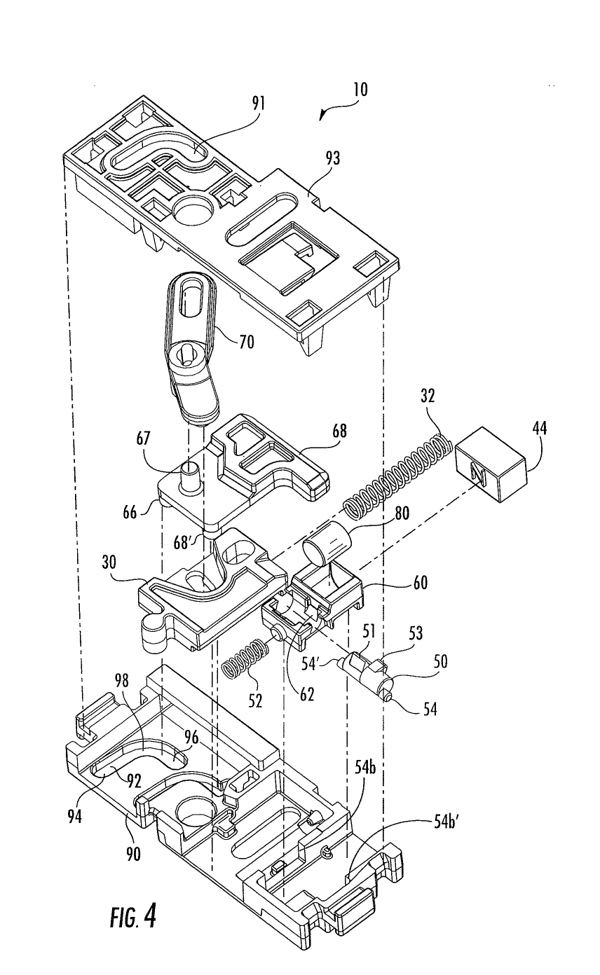

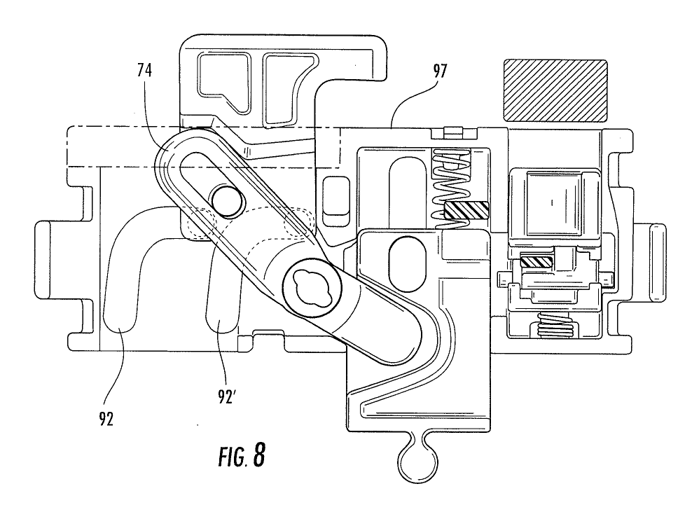

As shown more particularly in FIGS. 3-4, lock 10 includes button 30 and spring 32 attached to button 30 for biasing button 30 to move from an unlocked position (FIG. 6) to a locked position (FIG. 7), spring clip 40 (specifically spring clip flange 41) in contact with button 30 (specifically button flange 31) for holding button 30 in the unlocked position (see FIGS. 9 and 11), and trigger 50 (specifically first protrusion 51) for engaging with spring clip 40 (specifically second spring clip flange 43) to release button 30 and allow spring 32 to move button 30 toward the locked position (see FIGS. 9 and 11).

Lock 10 also includes hook 68 for moving from an unlocked position to a locked position in correspondence with button 30 moving from the unlocked position to the locked position, and arm 70 with one end 72 attached to button 30 and another end 74 attached to hook 68, wherein arm 70 transmits a movement of button 30 to a movement of hook 68. In some embodiments, arm 70 is rotatable.

In another embodiment, trigger 50 includes second spring 52 to move trigger 50 from a locked position to an unlocked position, where second spring 52 is separate and independent from spring 32.

As shown in FIGS. 3-4, lock 10 further comprises magnet 80 in contact with trigger housing 60 which in turn is in contact with trigger 50, wherein magnet 80 actuates trigger housing 60 which causes trigger 50 to engage with spring clip 40.

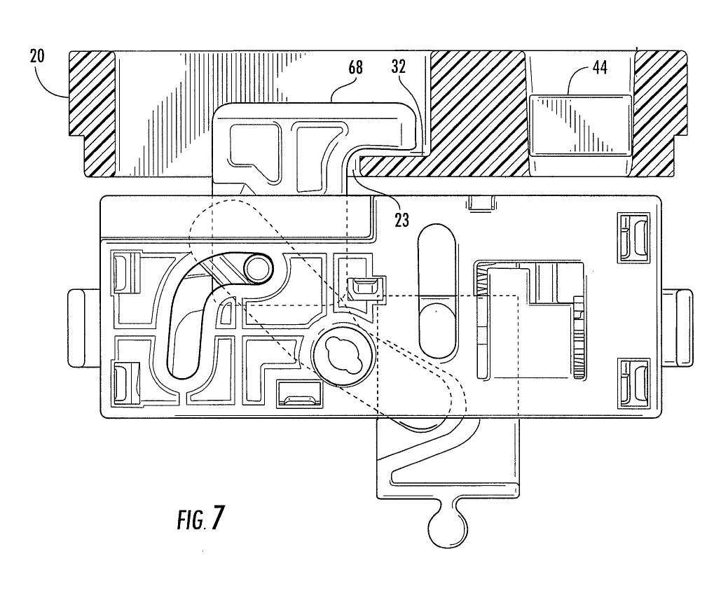

In a further embodiment, the housing includes base 90 and lid 93, where base 90 is in communication with hook 68 and where base 90 includes L-shaped channel 92 having generally vertical section 94, generally horizontal section 96, and arc section 98 connecting generally vertical section 94 with generally horizontal section 96. In some of these embodiments, hook 68 includes post 66 placed within L-shaped channel 92 for guiding a movement of hook 68 within the L-shaped channel 92. In other embodiments and shown in FIG. 8, base 90 includes second L-shaped channel 92′ for inhibiting undesired rotation of hook 68 relative to base 90 or hook 68 relative to post 66. In these embodiments, hook 68 includes second post 66′ to be placed in second L-shaped channel 92′.

As shown in FIG. 4, hook 68 includes arm post 67 for connecting end 74 of rotatable arm 70 with hook 68, and where a movement of rotatable arm 70 and a movement of hook 68 is guided by L-shaped channel 91 in lid 93. As shown in FIGS. 1-19, it is understood that L-shaped channels 91, 92′ have all of the limitations of L-shaped channel 92. As shown, all L-shaped channels are the same geometry. In further embodiments, and shown in FIGS. 20-32, the L-shaped channels have different widths and different dimensions.

It is understood that the shape or geometry of channels 91, 92, 92′ affect the movement of hook 68, and more particularly the engagement of hook 68 within strike 20. In some embodiments, a shorter or longer vertical movement and/or a shorter or longer horizontal movement for hook 68 are achieved by a variation in a shape of channels 91, 92, 92′. In another embodiment, channels 91, 92, 92′ have a straight geometry. In other embodiments, the respective vertical sections of channels 91, 92, 92′ are set at an angle relative to the horizontal sections of channels 91, 92, 92′. The angle is acute in some cases and obtuse in other cases. In further embodiments, the number of channels for guiding hook 68 is four or more. In some of these embodiments, a plurality of channels are used. In an optional embodiment, the amount of channels used for guiding hook 68 is one or two.

As shown in FIGS. 6-8, rotatable arm 70 is driven to rotate about pivot 76 by button 30, where end 72 of rotatable arm 70 is placed within crevice 34 of button 30. As button 30 is driven in a generally downward direction (in the orientation shown in FIGS. 6-8) by spring 32, crevice 34 rotates end 72 in a generally clockwise direction about pivot 76. As a result, other end 74 also rotates in a generally clockwise direction causing arm post 67 and posts 66, 66′ to move from their respective vertical sections to horizontal sections, which results in hook 68 moving upwards from lid surface 97 before moving toward the right to engage with shoulder 22. The upward movement of hook 68 is for facilitating engagement with, and in some cases ensuring engagement with, shoulder 22. Without sufficient vertical or upward movement, hook 68 may hit side 23 of shoulder 22 and may not engage properly with shoulder 22 to lock sashes 12, 14. As shown, rotatable arm 70 transmits a generally vertical or linear movement of button 30 to a generally vertical movement of hook 68 in an opposite direction of button 30 followed by a generally horizontal movement of hook 68, or movement generally perpendicular to the linear movement of button 30.

As shown in FIGS. 1-3, closing window 8 means bringing sashes 12, 14 together. Also as shown, strike magnet 44 is located within strike 20 and is a repelling magnet because it has the same polarity as magnet 80, and wherein placing strike magnet 44 proximate to magnet 80 causes magnet 80 to move away from strike magnet 44. Therefore, as sashes 12, 14 are brought together, strike magnet 44 repels magnet 80 and this movement of magnet 80 causes trigger 50 to likewise move and such movement of trigger 50, as described above, causes hook 68 to engage with shoulder 22. As described, lock 10 automatically locks window 8 once sashes 12, 14 are brought together and no other user invention is needed. In addition, no contact is needed between lock 10 and strike 20 in order for lock 10 to automatically operate and for hook 68 to automatically engage strike and secure sashes 12, 14 together.

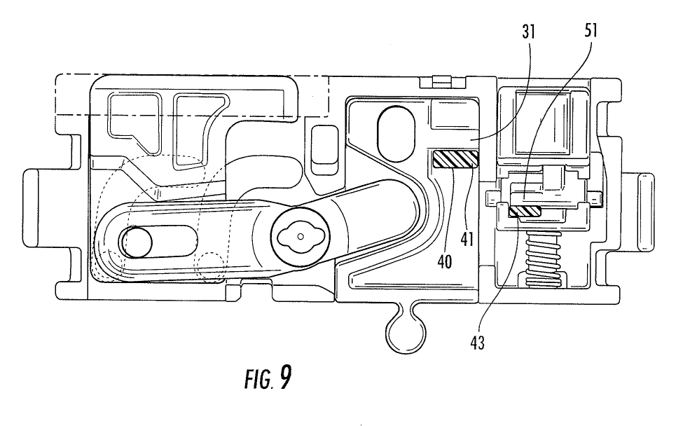

Once trigger 50 is in a downward motion, it will engage with second spring clip flange 43 of spring clip 40 to release the hold of spring clip 40 on button 30 and allow spring 32 to bias button 30 downwardly from the unlocked position to the locked position. As shown more particularly in FIG. 10, trigger 50 includes first protrusion 51 and second protrusion 53, where first protrusion 51 pushes second spring clip flange 43 and spring clip 40 away from surface 58 of trigger 50 and away from button 30. This pushing away releases the hold of spring clip flange 41 upon button flange 31.

Second protrusion 53 is placed adjacent to first protrusion 51 but second protrusion 53 does not come in contact with spring clip 40. Instead, second protrusion 53 contacts upper wall 62 of trigger housing 60, which inhibits first protrusion 51 from rotating away from, or in a clockwise direction shown in FIG. 10, second spring clip flange 43 (also see FIG. 4). As shown, second protrusion 53 extends from surface 58 in a different direction than first protrusion 51. In some embodiments, second protrusion 53 extends in a radial direction that is different from a radial direction of first protrusion 51. In other embodiments, second protrusion 53 extends tangentially from surface 58 in a different direction than a tangentially extending first protrusion 51.

To unlock window 8, the user engages push plate 18 by pushing upon it and this causes button 30 to be pushed upwards (in the orientation shown in FIG. 6), toward the unlocked position and compressing spring 32. Continued upward movement results in spring clip 40 re-engaging with button 30 to hold button 30 in the unlocked position. Because end 74 of rotatable arm 70 is maintained within crevice 34, arm 70 rotates in a generally counterclockwise rotation (in the orientation shown in FIGS. 6-8), resulting in hook 68 disengaging from shoulder 22 and post 66 moving to from generally horizontal section 96 to generally vertical section 94, wherein hook 68 is flush with or below surface 97 of lid 93. In this position, sashes 12, 14 are unlocked from one another and may be moved apart resulting in window 8 being opened.

Since sashes 12, 14 are spaced apart and window 8 may be open, repelling magnet 44 and magnet 80 are no longer in close proximity to one another resulting in second spring 52 biasing trigger 50 to the unlocked position without resistance from repelling magnet 44 inhibiting magnet 80 (and therefore trigger 50 due to magnet 80 being connected or attached to trigger 50) from moving in this direction.

As shown, as trigger 50 moves toward the unlocked position (the position shown in FIGS. 6 and 9), first protrusion 51 comes in contact with second spring clip flange 43 and rotates away from a movement of trigger 50, or in a counterclockwise direction shown in FIG. 10, as trigger 50 continues toward the unlocked position. After passing under second spring clip flange 43, lugs 54, 54′ come in contact with reset walls 54b, 54b′ (see FIG. 4), which causes trigger 50 to rotate until first protrusion 51 is in a position to re-engage with spring clip 40. In some of these embodiments, the rotation due to lugs 54, 54′ coming in contact with reset walls 54b, 54b′ continues until second protrusion 53 comes in contact with upper wall 62.

In another embodiment, as trigger 50 moves toward the unlocked position (the position shown in FIGS. 6 and 9), trigger 50 rotates about lug 54 that is attached to and extends from trigger 50 in an axial direction. As shown, lug 54 has a longitudinal axis spaced apart from a longitudinal axis of trigger 50 and there are two lugs 54, 54′. While moving toward the unlocked position; first protrusion 51 hits or contacts second spring clip flange 43 and rotates in a clockwise direction (orientation in FIG. 10) as trigger 50 continues moving toward the unlocked position. After passing under second spring clip flange 43, due to the continued upward movement of trigger 50, trigger 50 begins its clockwise rotation once lugs 54, 54′ come in contact with reset walls 54b, 54b′. The rotation continues until second protrusion 53 makes contact with upper wall 62, whereupon rotation will stop and first protrusion 51 will be in a position to re-engage with spring clip 40 to release button 30, or in other words trigger 50 will be in the same or similar position shown in FIGS. 6 and 9.

As shown, a movement of trigger 50 from the locked position to the unlocked position is independent of a movement of button 30. In some embodiments, the movement of trigger 50 from the locked position to the unlocked position is independent of a movement of button from the locked position to the unlocked position.

However, this independence is not in the unlocked to the locked position. As described above, a movement of trigger 50 from the unlocked position to the locked position actuates a movement of button from the unlocked position to the locked position.

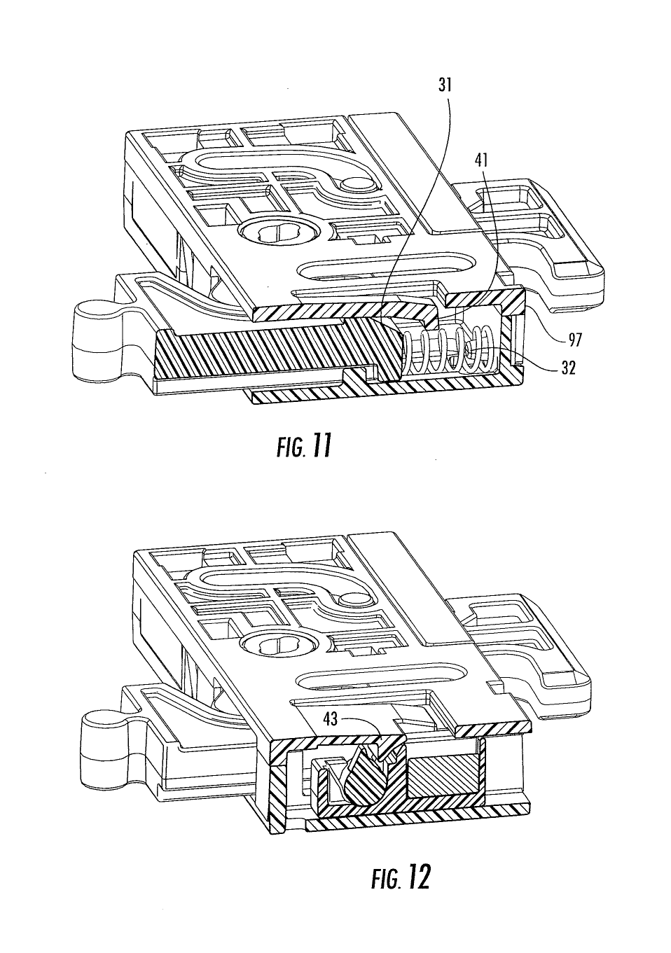

In another aspect of the invention, FIG. 13 depicts method 200 for providing lock 10 shown in FIGS. 1-12, comprising the steps of holding 202 a button in an unlocked position; attaching 204 a spring to the button for biasing the button toward a locked position; connecting 206 the button to a hook for locking a window when the button is biased from the unlocked position to the locked position; and placing 208 an arm between the hook and the button to transmit movement from the button to movement to the hook.

It is understood that attaching 204 a spring to the button includes the step of placing the spring adjacent to the button and that the spring need not be fixed to the button for the lock to function properly. In another embodiment, the spring is attached or connected to the button.

In other embodiments, method 200 includes the step of holding 212 the button in the unlocked position with a spring clip. In some of these embodiments, method 200 includes the step of placing 214 a trigger proximate to the button for engaging the spring clip, which releases the hold on the button and allows the spring to bias the button toward the locked position. In a further embodiment, method 200 places 218 a magnet proximate the trigger for actuating the trigger to engage with the spring clip.

In another embodiment, method 200 places 222 a repelling magnet proximate to the magnet for causing the magnet to repel away from the repelling magnet and actuate the trigger. In a further embodiment, magnet 222 is an attracting magnet.

In yet another embodiment, method 200 further comprises the step of translating 224 a generally linear movement of the trigger to a movement of the hook that is generally perpendicular to the movement of the trigger.

In further embodiments, method 200 attaches 226 a second spring to the trigger for biasing the trigger toward the unlocked position.

In some embodiments, method 200 moves 228 the button from the locked position to the unlocked position independently from the step of biasing the trigger from the locked position to the unlocked position. In an optional embodiment, method 200 includes the step of biasing 230 the trigger to the unlocked position without engaging the spring clip.

What follows is a more detailed description of the operation of lock 10. For opening window 8, button 30, which is normally biased out of the housing by the use of a compression spring, is held in the inward direction by a detent clip, or spring clip 40, feature on the polymer lid or attached to the button. The locking hook 68 is in turn held within the lock housing by the use of a drive arm 70 that is pivoted in the lock housing and in turn driven by button 30.

When closing window 8, sashes 12, 14 are brought together and lock 10 automatically and without user intervention secures sashes 12, 14 together via hook 68. Repelling magnet 44 is housed in a strike that is mounted to the rear sash of the window. When the front sash, in which the lock mechanism is mounted, is pushed closed, the striker magnet 44 and the lock magnet 80 are aligned. In this position, the two magnets are orientated so that one of the poles (e.g. North) on the strike magnet and the same pole on the lock magnet are facing each other. This creates an opposing force. The opposing force drives the trigger mechanism (consisting of trigger housing 60, trigger 50, lock magnet 80 and compression spring 52) away from the striker 20, and toward the inside (or downward direction as shown in FIG. 9) of lock housing (lid 93 and base 90). The trigger wheel 50, mounted in the trigger housing 60, has first protrusion 51 that lifts the detent clip 40 on lid 93. This protrusion travels beyond the lifting ramp on the detent and comes to rest in a clear space behind the detent. When the clip is lifted out of the detent position in the button, the compression spring biasing the button out is allowed to drive the button to its rest position. This in turn drives the locking hook 68 out and into the strike.

To open window 8, the button is pushed into the lock housing and in turn the locking hook is pulled out of the strike and into the lock housing. The detent clip 40 on lid 93 engages button 30 and holds the button against the force of the compression spring 32. The detent is allowed to happen because in this state, the trigger mechanism is still in clear space behind the detent clip due to the opposing magnetic forces. In this state the window is free to be opened.

Once the front sash is lifted away from the strike, the trigger mechanism resets to a state that will allow the trigger wheel protrusion to lift the polymer detent once again if the two magnets in the system are again aligned. Because the opposing force from the strike magnet is no longer in play, the trigger mechanism return spring is now allowed to push the trigger mechanism back to the primed position. While the trigger slide is moving towards the primed position, the trigger wheel rotates so that the protrusion travels under the detent clip without lifting the detent clip. When the trigger slide nears its home/primed position, lugs on the trigger wheel hit walls on the lock housing and rotate the trigger wheel back to its primed position.

Features of lock 10 include a two motion locking hook travel, wherein the locking hook is driven by the drive arm via the button, it first moves in the outwards direction, and in the second part of the travel, it moves horizontally so that the hook part of the locking hook is allowed to travel firstly into the strike and then horizontally to engage the hook behind the strike.

In an optional embodiment, shown in FIG. 33, foot 77 is engaged with housing receiver 79 when hook 68 is in the locked position. This provides enhanced strength and integrity to lock 10.

Another feature of lock 10 is an anti-picking device—this reduces the chance of forcing the bolt out of the striker when the lock is in the fired position. There are three tracks in which the locking hook travels. Two, in base 90, determine the motion of the locking hook, and a third in the polymer lid 93 that prevents the locking hook from racking. The inwards track has an additional portion that allows the corresponding boss on the locking hook to move into a ‘locked out’ position if the hook is manipulated during a forced entry.

A further feature is the flexibility to open window 8 in any one of four ways: direct push of the button, top and bottom mounted feature on the button to drive button from the top or bottom of the lock, a pivot feature built into the drive arm pivot 76, and a standoff or handle extending from arm 70 on any part of arm 70 and in a generally perpendicular direction away from drive arm 70 in an generally upward direction (upward when lock 10 is positioned as shown in FIG. 11).

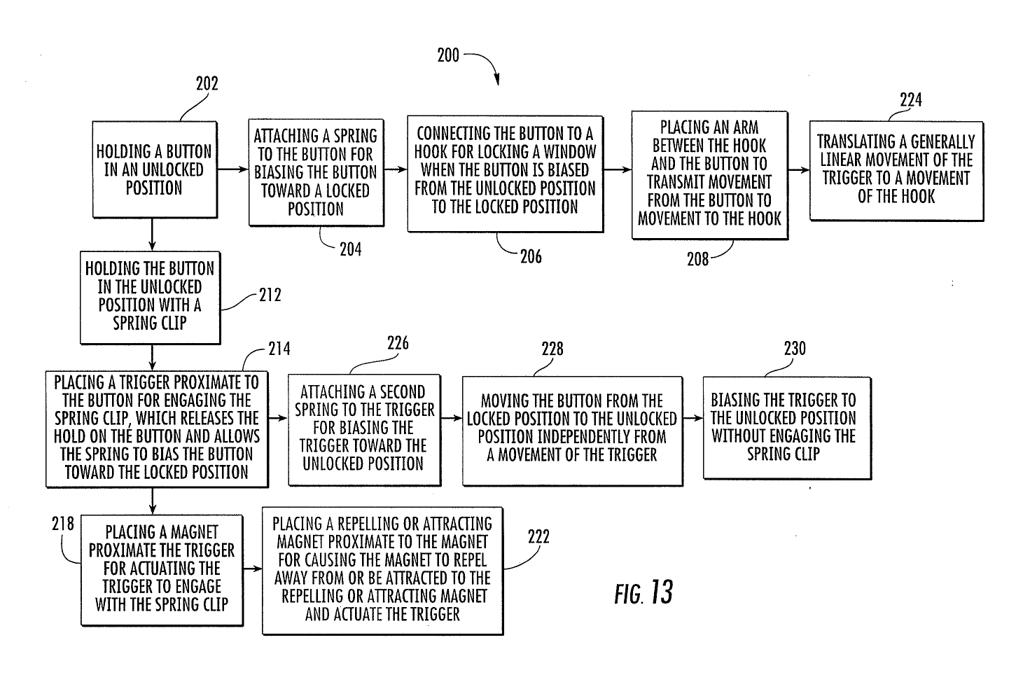

In another aspect of the invention shown in FIGS. 14-18, strike magnet 44 is not a repelling magnet but is an attracting magnet because it attracts magnet 80 toward attracting magnet 44. As shown, trigger 120 and second spring 122 switched positions with each other relative to the positions shown in FIGS. 1-13.

Because attracting magnet 114 attracts magnet 116 within trigger 120, magnet 116 and trigger 120 tend to move toward attracting magnet 114 when both magnets are placed proximate to each other, which is when sashes 12, 14 are brought together or window 8 is closed.

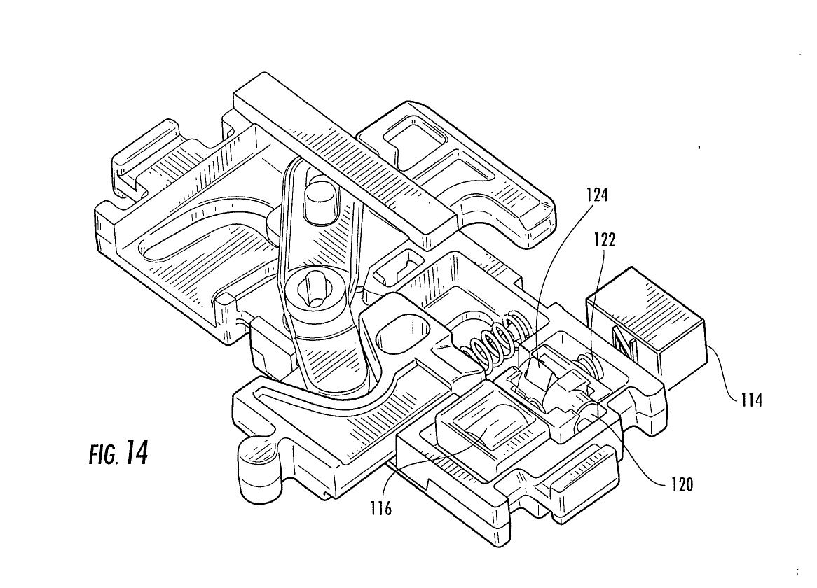

When magnet 114 moves upward in the orientation shown in FIGS. 15-16, first protrusion 124 pushes spring clip 40, which releases button 30 from the unlocked position and allows spring 32 to bias button 30 as stated above under FIGS. 1-13.

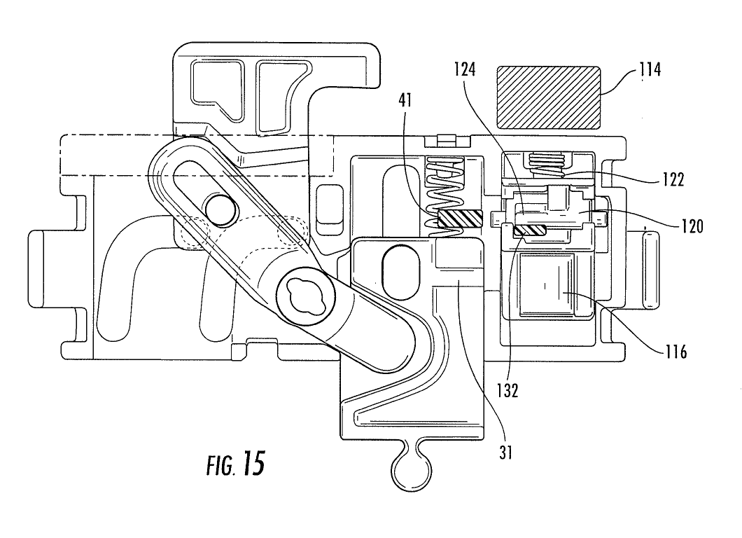

As shown in FIG. 17, second spring clip flange 132 varies from second spring clip flange 43 in that ramped surface 133 faces an opposite direction in FIG. 17 than in FIG. 10. This is because trigger 120 and first protrusion 124 of FIGS. 14-17 are moving upward toward attracting magnet 114, whereas trigger 50 and first protrusion 51 of FIGS. 1-13 are moving downward away from repelling magnet 44. However, the purpose of trigger 120 is to engage with spring clip 40 to release its hold on button 30, and therefore any direction of travel for trigger 120 is acceptable and within the scope and spirit of lock 10.

As shown in FIG. 16, lock 10 is in an unlocked position where hook 68 is retracted within the housing (base 90 and lid 93). Second spring clip flange 132 is located above first protrusion 124 and, similar to FIGS. 1-13, spring clip flange 41 is holding button flange 31 and button 30 in the unlocked position.

When sashes 12, 14 are brought together, it causes magnet 116 to move upward toward the position shown in FIG. 15, which is above second spring clip flange 132. In the process, first protrusion 124 engages with ramped surface 133 which in turn causes spring clip 40 to move away from surface 58 of trigger 120 to release button 30. Once passing second spring clip flange 132 due to magnet 116 moving toward attracting magnet 114, it results in the position shown in FIG. 15.

Similar to the use of second spring 32, second spring 122 in FIGS. 14-17 return first protrusion 124 and trigger 120 to the unlocked position when attracting magnet 114 and magnet 116 are moved away from each other, such as when window 8 is open. First protrusion 124 passes under second spring clip flange 132 and rotates into a position to re-engage with second spring clip flange 132 in the same manner as described herein. For attracting magnet 114 to attract magnet 116, both magnets have opposite polarity to one another. Therefore, one magnet has a north polarity and the other magnet has a south polarity.

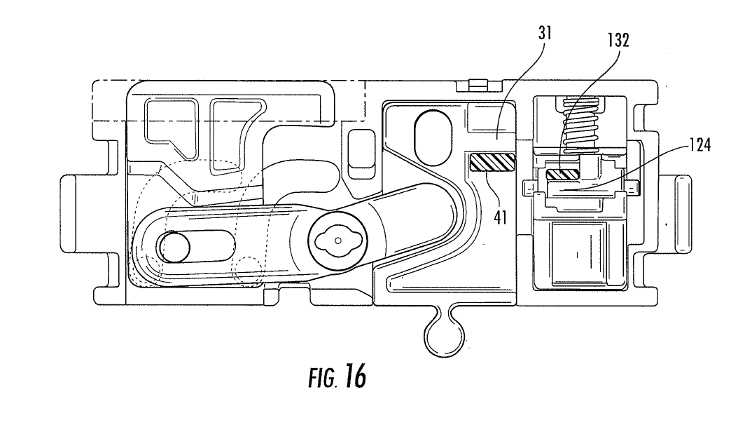

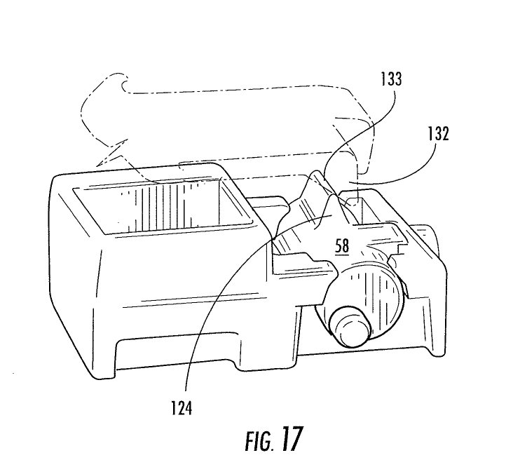

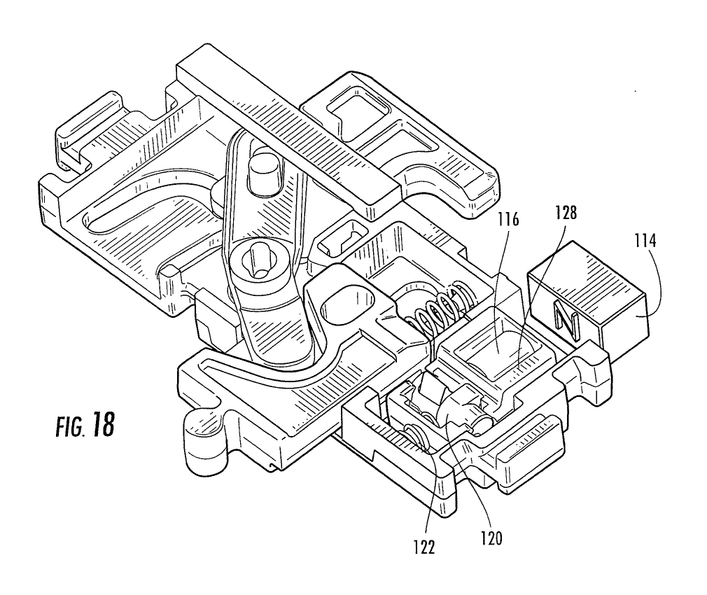

FIG. 18 depicts a variation of lock 10 using attracting magnet 114 where trigger 120, second spring 122, and trigger housing 128 have the same relation to the rest of the components of lock 10 as described in FIGS. 1-13. In this variation, second spring 122 is a tension spring (FIGS. 1-17 describe second spring as a compression spring) that biases trigger 120 toward the locked position or away from attracting magnet 114.

Therefore, when sashes 12, 14 are brought together, trigger 120 and magnet 116 are moved toward attracting magnet 114, and in the process engage with second spring clip flange 132 and release button 30. When window 8 is open, attracting magnet 114 is moved away from magnet 116 and tension spring 122 biases trigger 120 toward the unlocked position, or downward in the orientation shown in FIG. 18.

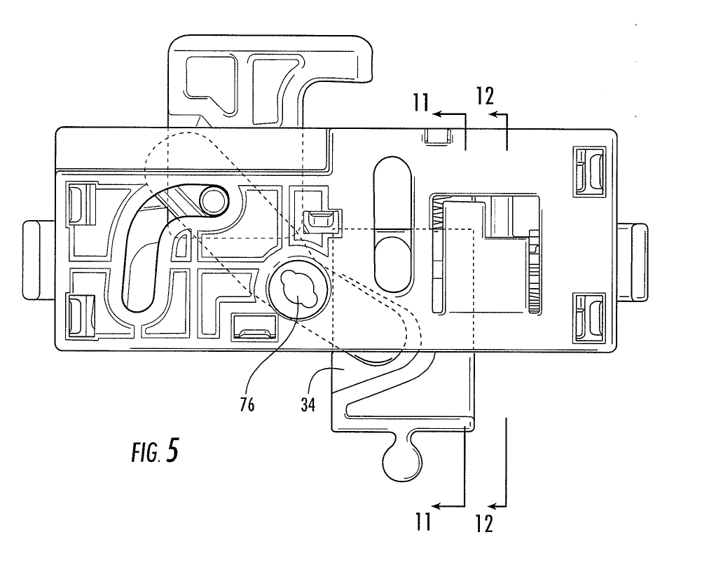

FIG. 19 depicts push plate 18 being used as an indicator for indicating when lock 10 is in a locked or unlocked position. To open window 8 after lock 10 has locked the two sashes 12, 14 together, and wherein hook 68 is engaged with strike 20 and shoulder 22, a user may push upon push plate 18. Pushing upon push plate 18 results in a push upon button 30 (in the upward direction when lock 10 is in the orientation shown in FIGS. 5-9). When button 30 is pushed in this upward direction, hook 68 is moved to the unlocked position. Therefore, button 30 remaining in the upward direction means hook 68 and lock 10 is in the unlocked position.

Attaching push plate 18 to button 30, whether directly or indirectly, gives a visual indication to the user as to when lock 10 is locked or unlocked because if button 30 is in the unlocked position (FIG. 6), push plate 18 is pushed in as shown in FIG. 19. If button 30 is in the locked position (downward as shown in FIG. 5), push plate 18 will not pushed in.

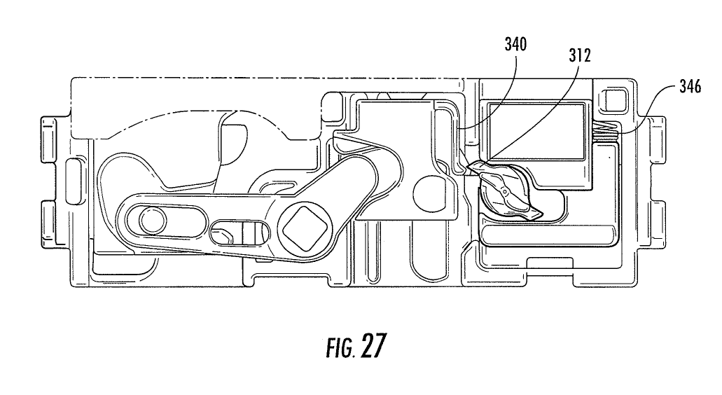

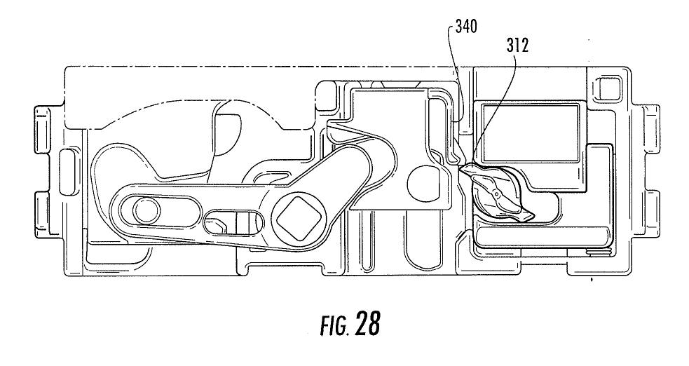

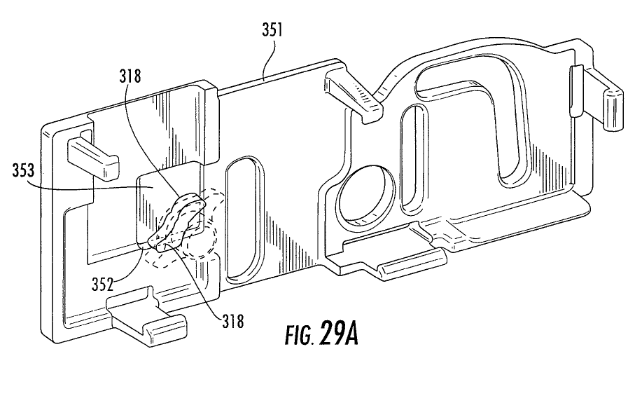

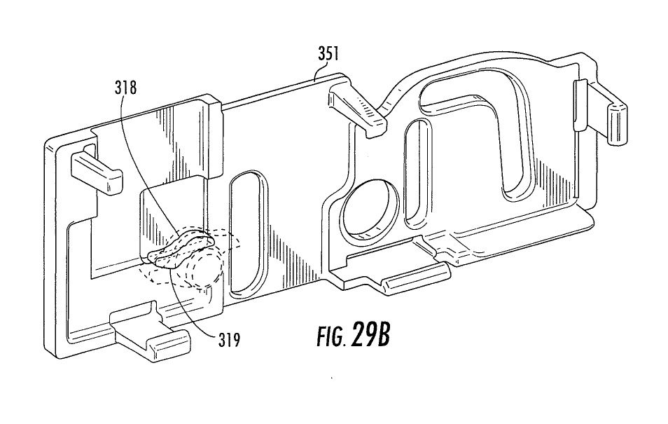

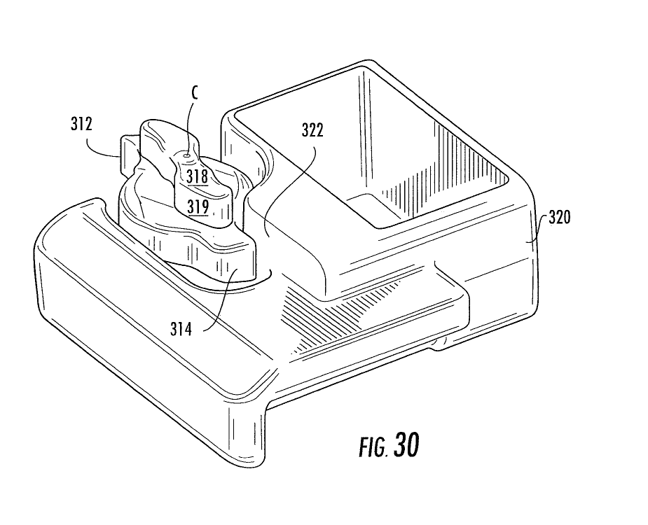

In another embodiment shown in FIGS. 20-32, lock 300 includes trigger wheel 310 having first protrusion 312 and second protrusion 314. Lock 300 also includes trigger housing 320 for holding trigger wheel 310 and magnet 330, which is an attracting magnet that attracts magnet 44 and which causes trigger housing 320 to move toward magnet 44 and sash 12. Trigger wheel 310 rotates freely about its point C but housing wall 322 and housing shelf 352 represent general limits of the rotation of trigger wheel 310 because wall 322 and housing shelf 352 inhibit rotation of second protrusion 314 between two positions, or two stops. See also FIGS. 30 and 32 for a close up view of trigger housing 320 and trigger wheel 310. In addition, as explained below, contact of first protrusion 312 with spring clip 340 also affects the range of rotation of trigger wheel 310.

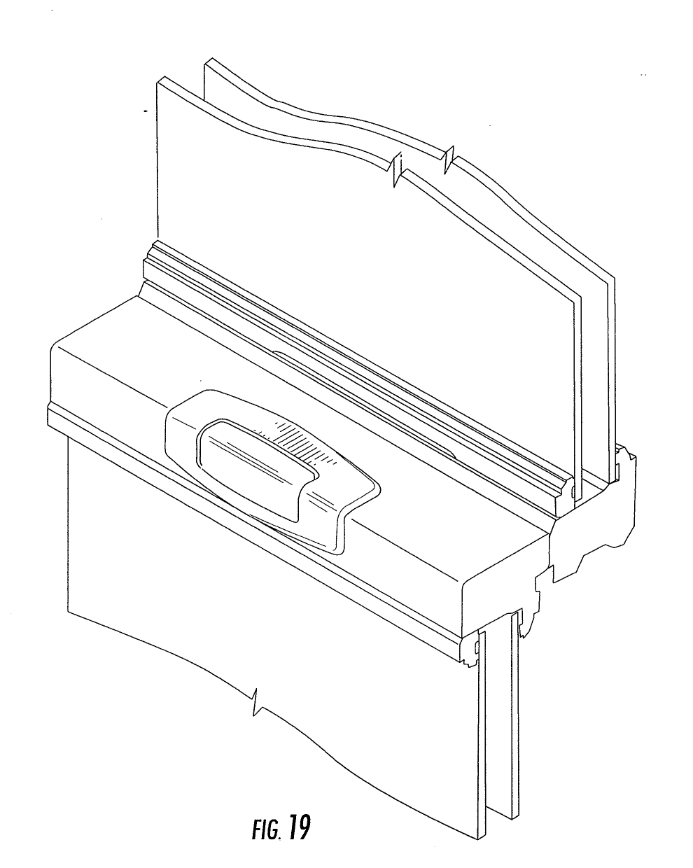

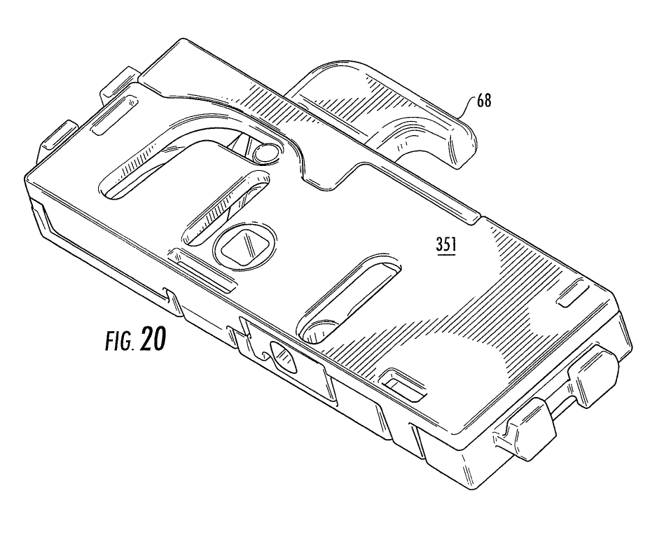

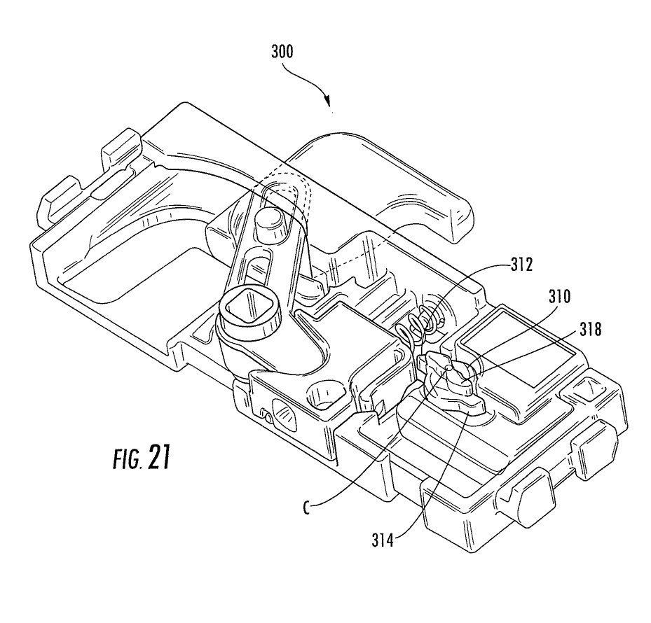

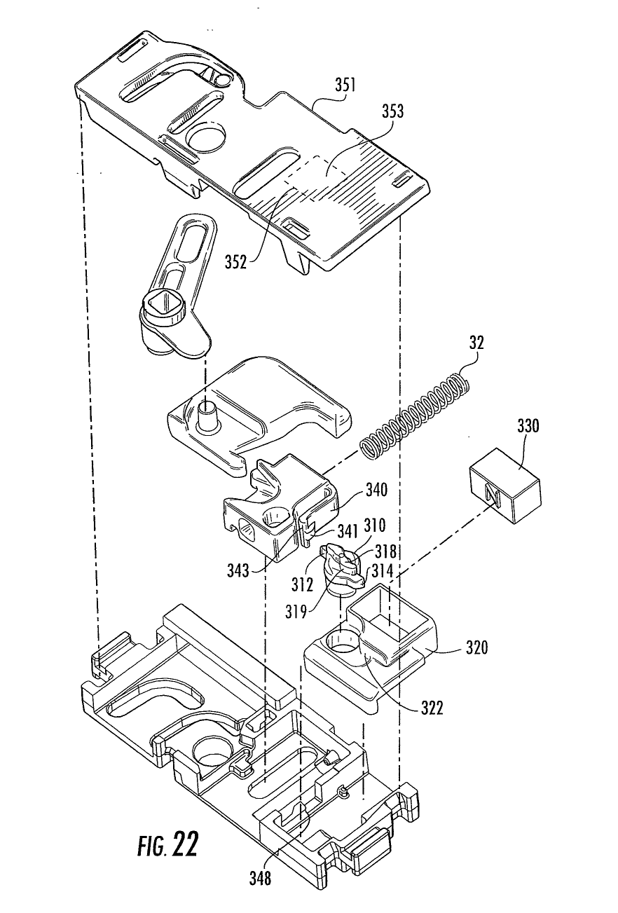

As shown more particularly in FIGS. 21-22, lock 300 includes spring clip 340 attached to button 30 for holding button 30 in the unlocked position (see FIG. 23), and trigger wheel 310 (specifically first protrusion 312) for engaging with spring clip 340 to release button 30 and allow spring 32 to move button 30 toward the locked position (see FIG. 25).

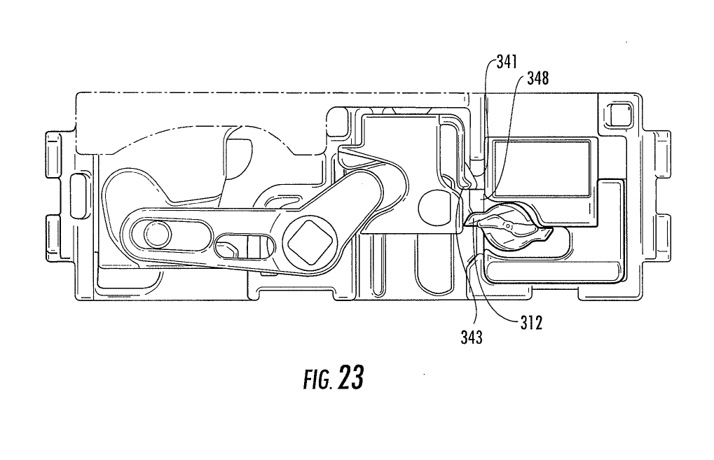

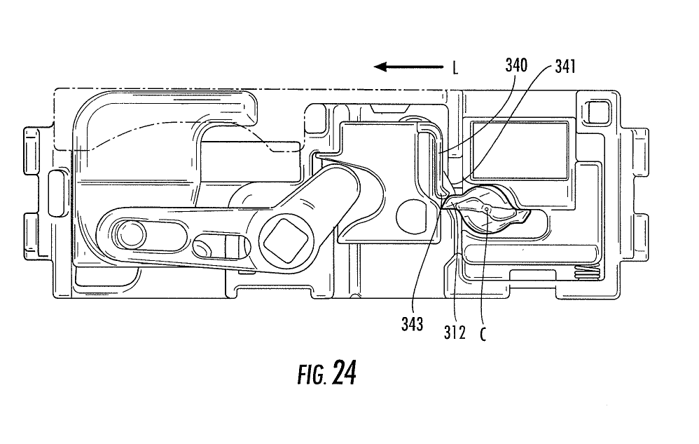

As shown in FIG. 24, when window 8 is closed, magnet 330 is attracted to magnet 44, which causes trigger housing 320 to move upwardly toward magnet 44. As trigger housing 320 moves upwardly, trigger wheel 310 also moves upwardly. As trigger wheel 310 moves upwardly, first protrusion 312 comes in contact with spring clip 340, which causes or tends to cause trigger wheel 310 to rotate in a counterclockwise direction. However, as trigger wheel 310 rotates counterclockwise, second protrusion 314 comes into contact with trigger housing wall 322, which inhibits counterclockwise rotation of trigger wheel 310 (this defines the first position or first stop mentioned above). Similar to lock 10, lock 300 automatically locks window 8 when sashes 12, 14 are brought together and no other user intervention is needed. No contact is needed between lock 300 and strike 20 in order for lock 300 to automatically operate and for hook 68 to automatically engage strike 20 and secure sashes 12, 14 together.

As trigger housing 320 and trigger wheel 310 continue their upward movement, and when first protrusion 312 contacts second portion 343 of spring clip 340 (see FIGS. 22 and 24), first protrusion 312 causes spring clip 340 (due to the flexibility of spring clip 340 relative to the inflexible wall 322) to move away from first protrusion 312 (as shown in FIG. 24, spring clip 340 moves leftwards in direction L when first protrusion 312 pushes it). As spring clip 340 moves away from first protrusion 312, spring clip 340 (specifically first portion 341 of spring clip 340) also moves away from half wall 348 and, as a result, releases button 30 from the unlocked position and permits spring 32 to decompress and automatically cause hook 68 to extend from housing 351 and lock window. See FIGS. 25 and 31.

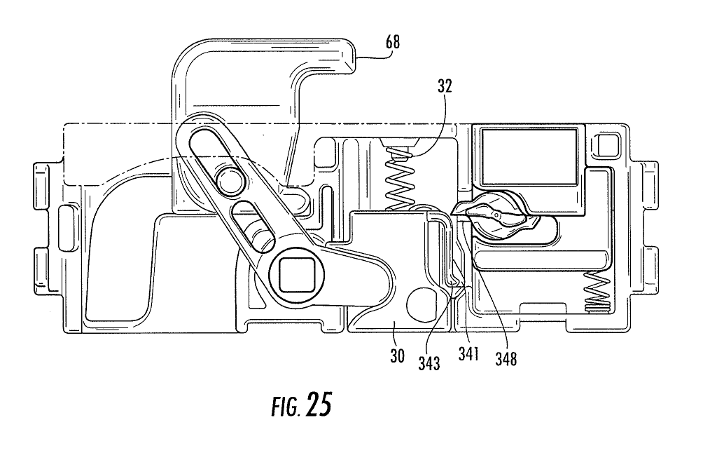

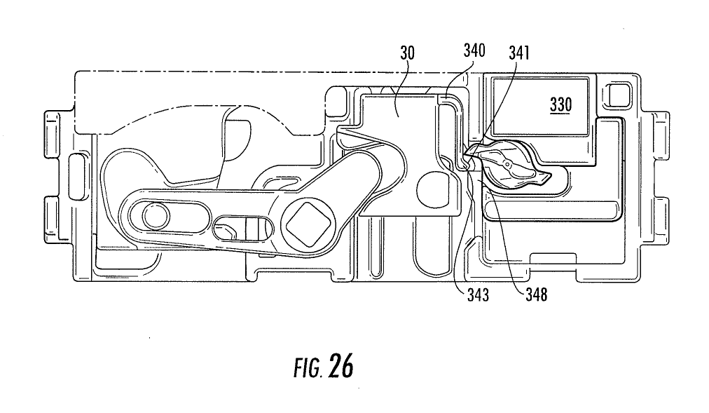

In order to reset lock 300, the window is first unlocked by a user (see FIG. 26). Because the user is unlocking the window, hook 68 is forced back into lock 300 but magnet 330 is still at the upward position because it is still being attracted by magnet 44. In this position, button 30 is placed in the unlocked position where half wall 348 is now holding first portion 341 of spring clip 340 and button 30. It is understood the invention is not limited to the shown embodiments of first and second portions 341, 343, where both have different cross sections even though both are a part of spring clip 340. In other embodiments, first and second portions 341, 343 have the same cross section or same physical characteristics as one another.

When the window is opened and magnet 330 is moved away from magnet 44, the attraction between the magnets is reduced and magnet 330 begins to move downwardly due to spring 346 biasing trigger housing 320 to the deactivated position (see FIG. 27) until first protrusion 312 comes in contact with spring clip 340. However, because there is no wall coming in contact with trigger wheel 310 in order to control its rotation, trigger wheel 310 rotates clockwise around spring clip 340 and second portion 343 without moving spring clip 340. See FIG. 28.

As spring 346 continues to bias trigger housing 320 downwardly, trigger wheel 310 returns to the original deactivated position as shown in FIG. 23. In some cases, shown in, FIGS. 29a-29b, trigger wheel 310 returns to this position by third protrusion 318 (third protrusion 318 is connected to trigger wheel 310) coming in contact with housing shelf 352 as trigger wheel 310 is being biased in the downward direction.

As shown, third protrusion 318 stays within square recess 353 at all times, even during all movement of trigger wheel 310. As trigger wheel 310 moves downwardly toward the deactivated position, bottom surface 319 of third protrusion 318 comes into contact with housing shelf 352, or the bottom surface of square recess 353.

As bottom surface 319 of third protrusion 318 comes in contact with housing shelf 352, and as spring 346 continues to bias trigger housing 320 downwardly, housing shelf 352 inhibits counterclockwise rotation of trigger wheel 310 (counterclockwise of trigger wheel 310 in FIGS. 29a-29b but clockwise rotation in FIG. 27). However, because trigger housing 320 is moving downwardly, trigger wheel 310 will rotate clockwise in FIGS. 29a-29b due to contact between bottom surface 319 and housing shelf 352. Such clockwise rotation continues until trigger wheel 310 resumes the deactivated position shown in FIG. 23.

As shown above, a movement of trigger wheel 310 and trigger housing 320 from the activated position to the deactivated position is independent of a movement of button 30. In some embodiments, the movement of trigger wheel 310 and trigger housing 320 from the activated position to the deactivated position is independent of a movement of button 30 from the locked position to the unlocked position.

However, this independence is not in the deactivated to the activated position. As described above, a movement of trigger wheel 310 and trigger housing 320 from the deactivated position to the activated position actuates a movement of button 30 from the unlocked position to the locked position.

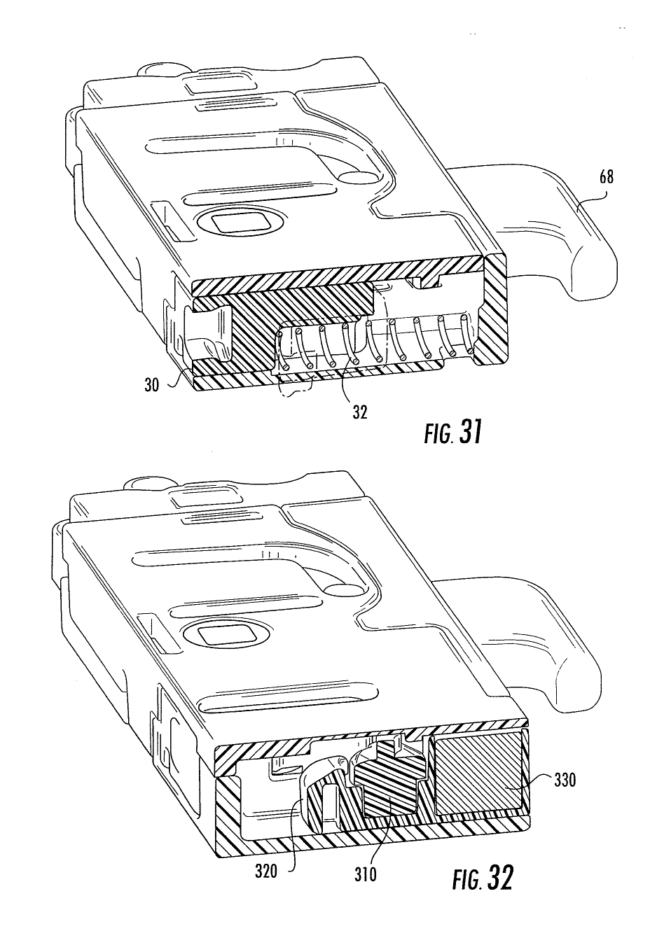

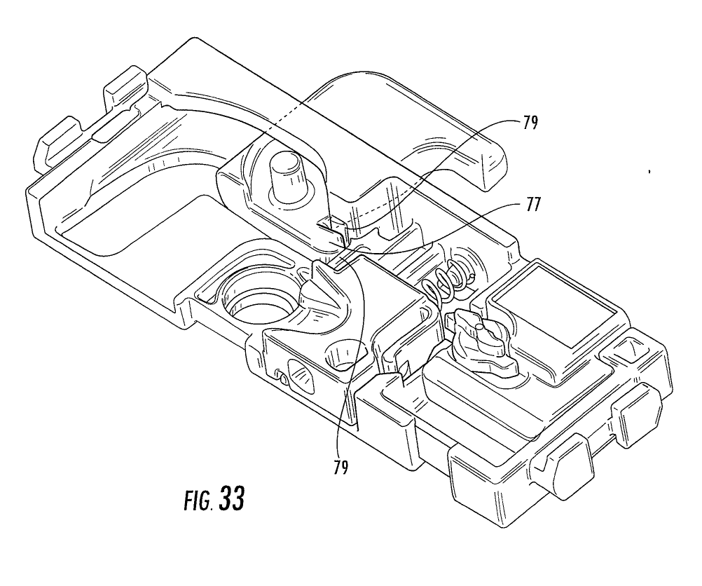

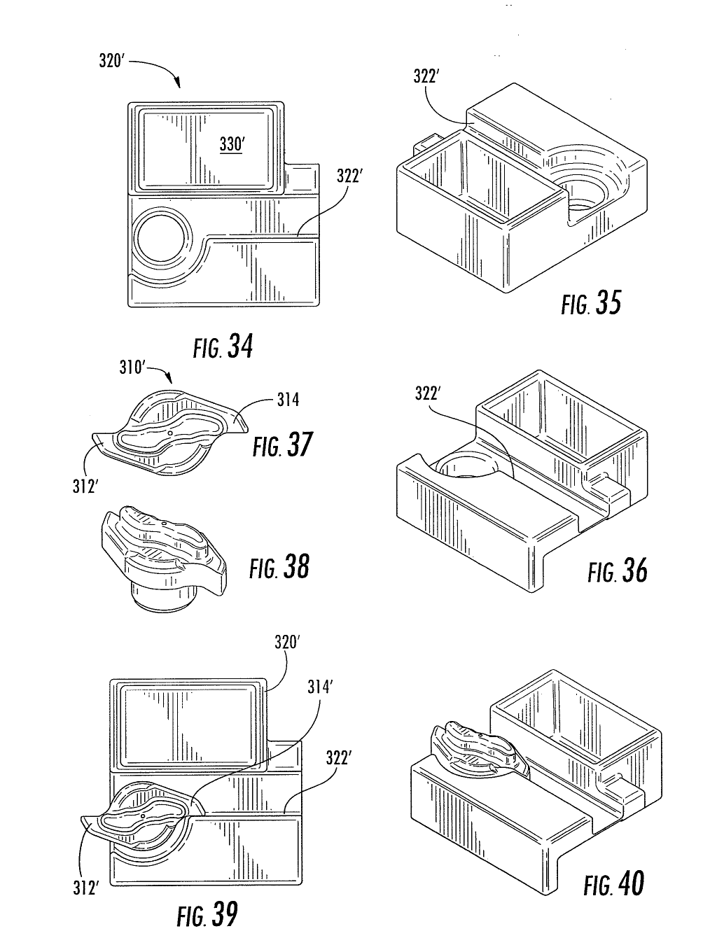

In another embodiment and as shown in FIGS. 34-40, repelling magnet 330′ is placed in trigger housing 320′, which causes trigger housing 320′ to move away from magnet 44 when window 8 is closed. As trigger housing 320′ moves downwardly from a top or deactivated position (as opposed to upwardly in FIG. 23 from a lower deactivated position), trigger wheel 310′ also moves downwardly. As trigger wheel 310′ moves downwardly, first protrusion 312′ comes in contact with spring clip 340, which causes or tends to cause trigger wheel 310′ to rotate in a clockwise direction. However, as trigger wheel 310′ rotates clockwise, second protrusion 314′ comes into contact with trigger housing wall 322′, which inhibits clockwise rotation of trigger wheel 310′. As a result, first protrusion 312′ moves spring clip 340 and button 30 is released from half wall 348.

Deactivation of trigger wheel 210′ and trigger housing 320′ as well as the process of unlocking the window is similar to the above description in FIGS. 20-32, but differs due to the general reversal of the deactivation and activation positions of trigger housing 320′ and trigger wheel 310′. In addition, housing shelf 352′ will be located at a top part of square recess 353 instead of at a bottom part.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A lock for a window, comprising
a button having a locked position and an unlocked position;
a spring clip in contact with said button for holding said button in the unlocked position;
a trigger wheel;
a trigger housing having an activated position and a deactivated position;
said trigger wheel is attached to and rotatable on said trigger housing;
wherein movement of said trigger housing causes said trigger wheel to move into contact with said spring clip; and
wherein said trigger wheel in contact with said spring clip causes said spring clip to move and allow said button to move from the unlocked position to the locked position.

2. The lock according to claim 1, said trigger wheel has a first protrusion and a second protrusion.

3. The lock according to claim 2, wherein said second protrusion rotates between a first position and a second position for controlling a rotation of said trigger wheel.

4. The lock according to claim 3, wherein said second position is defined by a second stop on a housing for controlling a clockwise rotation of said trigger wheel;
wherein contact between said trigger wheel and said second stop causes said trigger wheel to reset to the deactivated position when said trigger housing is in the deactivated position.

5. The lock according to claim 2, wherein movement of said trigger housing toward the activated position causes said trigger wheel to move;
wherein said second protrusion contacts said first stop and said first stop inhibits said first protrusion from rotating around said spring clip; and
wherein said first stop causes said first protrusion to contact and move said spring clip to allow said button to move from the unlocked position to the locked position.

6. The lock according to claim 1, said trigger housing includes a spring for biasing said trigger housing toward the deactivated position; and
said trigger housing includes a magnet and where actuation of said magnet causes said trigger housing to move from the deactivated position to the activated position.

7. The lock according to claim 1, wherein deactivation of said magnet allows said spring to bias said trigger housing toward the deactivated position.

8. The lock according to claim 1, wherein movement of said button from the locked position to the unlocked position causes said spring clip to come in contact with a wall and where said wall holds said spring clip and said button in the unlocked position.

9. The lock according to claim 8, wherein movement of said trigger housing toward the deactivated position causes said first protrusion to rotate around said spring clip without releasing said spring clip from said wall.

10. The lock according to claim 1, said trigger wheel freely rotates clockwise and counterclockwise about an axis passing through said trigger housing.

11. The lock according to claim 1, wherein said spring clip is attached to said button.

12. The lock according to claim 1, wherein said spring clip is attached to a housing.

13. A lock for a window, comprising
a button having a locked position and an unlocked position;
a spring clip in contact with said button;
a wall in contact with said spring clip for holding said button in the unlocked position;
a trigger wheel with a protrusion;
a trigger housing having an activated position and a deactivated position;
said trigger wheel is attached to and rotatable on said trigger housing;
said protrusion rotates between a first position and a second position for controlling a rotation of said trigger wheel.

14. The lock according to claim 13, wherein said first position is defined by a first stop on said trigger housing for controlling a counterclockwise rotation of said trigger wheel.

15. The lock according to claim 14, wherein said first stop, when in contact with said protrusion, inhibits movement of said protrusion and causes said trigger wheel to move said spring clip and allow said button to move from the unlocked position to the locked position.

16. The lock according to claim 13, wherein said second position is defined by a second stop on a housing for controlling a clockwise rotation of said trigger wheel.

17. The lock according to claim 16, wherein said second stop, when in contact with said trigger wheel, causes said trigger wheel to reset to the deactivated position when said trigger housing is in the deactivated position.

18. The lock according to claim 13, said spring clip has a first portion and a second portion; and
said wall is in contact with said first portion for holding said button in the unlocked position.

19. The lock according to claim 18, said protrusion contacts said second portion for moving said spring clip and allowing said button to move from the unlocked position to the locked position.
